(19) United States
(12) Patent Application Publication
(10) Pub. No.: US 2024/0093839 A1
(43) Pub. Date: Mar. 21, 2024

(54) VAPOR PLUG LOCKING COLLAR

(71) Applicant: Cryoport, Inc., Brentwood, TN (US)

(72) Inventor: Ben Lee, Corona, CA (US)

(73) Assignee: Cryoport, Inc., Brentwood, TN (US)

(21) Appl. No.: 17/945,859

(22) Filed: Sep. 15, 2022

(51) Int. Cl. F17C 13/06; F17C 3/08; F17C 13/00

(52) U.S. Cl. CPC F17C 13/06; F17C 3/08; F17C 13/002

(57) ABSTRACT

A system, method and apparatus, and/or device is provided for securing a vapor plug on a dewar. The vapor plug locking mechanism includes a vapor plug, and a cryogenic storage vessel. The vapor plug has a first pin. The cryogenic storage vessel has an opening and a neck ring around the opening. The neck ring comprises a first receiving channel. The first receiving channel has a first channel and a second channel extending at a first angle from an end of the first channel. The first receiving channel is configured to receive the first pin, wherein the pin slides into the first channel then rotates into the second channel.

### BACKGROUND

### 1. Field

This specification relates to a system, device or apparatus to secure a lid to a cryogenic storage vessel, such as a dewar, during transport, wherein pressure may be released from the cryogenic shipping container.

### 2. Description of the Related Art

Cryogenic storage vessels, such as dewars, dry vapor shippers, or other vessels, vent gas vapor to prevent the buildup of pressure inside of the vessel, which could cause the vessel to fail. These cryogenic storage vessels may retain vaporized liquid nitrogen (or dry vapor) to produce a cryogenic temperature in the vessel, also called a dewar. The cryogenic storage vessel is vacuum insulated and traps vapors to maintain extreme cold temperatures of approximately −195° C.

To maintain the cold temperature and prevent the releasing of the contents inside, the cryogenic storage vessel has a vapor plug, cork, lid or other capping mechanism that inserts on the neck of the cryogenic storage vessel. The vapor plug or lid keeps the temperature within a desired range and the contents inside. The vapor plug is designed to allow gases to escape from the cryogenic storage vessel. The vapor plug may move to allow the gas to escape, however a sudden jarring or movement of the cryogenic storage vessel may cause the vapor plug to dislodge from the neck of the cryogenic storage vessel. Thus, if the vapor plug is not retained within the dry vapor shipper and the vapor plug is dislodged during transit, thermal transmission will increase within the cryogenic storage vessel and the cryogenic storage vessel will warm more quickly and/or the contents of the cryogenic storage vessel may spill out.

Traditionally, the vapor plug of a cryogenic storage vessels moves freely to allow the venting of gasses. And so, when there are sudden movements during transit, the vapor plug may be dislodged from within the neck of the cryogenic storage vessel. This results in thermal transmission and increases the temperature within cryogenic storage vessel causing the contents to warm more quickly.

A retaining device may include a leash, wherein a flexible flat cord is tied to hold the vapor plug to the cryogenic shipping container. This however only tethers the vapor plug to the cryogenic shipping container. Another retaining device may include a belt system, wherein a belt and clasp fasten the vapor plug lid to the cryogenic shipping container. This system does retain the vapor plug but adjustments when fastening the belt vary the effectiveness of the vapor plug. Further, the retaining device may unintentionally dislodge causing the vapor plug lid to no longer remain on the cryogenic storage system.

Accordingly, there is a need for a system, device or apparatus to retain and lock the vapor plug on the cryogenic storage system, while still allowing for the release of gas.

### SUMMARY

In general, one aspect of the subject matter described in this specification is a vapor plug locking mechanism. The vapor plug locking mechanism seals or partially seals the vapor plug within the neck of the dewar during transport of the dewar to prevent the vapor plug from dislodging and allow for the release of gas.

The vapor plug locking mechanism includes a vapor plug and a cryogenic storage vessel. The vapor plug has a first pin. The cryogenic storage vessel has an opening and a neck ring around the opening. The neck ring has a first receiving channel. The first receiving channel has a first channel and a second channel extending at a first angle from an end of the first channel. The first receiving channel is configured to receive the first pin, wherein the pin slides into the first channel then rotates into the second channel.

These and other embodiments may optionally include one or more of the following features. The first channel may be relatively vertical, and the second channel may be relatively horizontal. The receiving channel may include an interference tab. The interference tab may be configured to selectively prevent the pin from rotating. The vapor plug may further include a gasket. The gasket may be configured to selectively seal the vapor plug to the neck of the cryogenic storage vessel. The vapor plug may further include a vapor plug handle. The handle may be configured to insert and rotate the vapor plug into the opening of the cryogenic storage vessel. The first pin may extend radially inward. The vapor plug may include a second pin and the neck may include at least two receiving channels. The cryogenic storage vessel may have a payload area. The payload area may be accessed by the opening of the cryogenic storage vessel.

In another aspect, the subject matter is embodied in a vapor plug locking mechanism. The vapor plug locking mechanism includes a cryogenic storage vessel, an opening of the cryogenic storage vessel and a vapor plug. The cryogenic storage vessel contains a material below an ambient temperature. The opening of the cryogenic storage vessel has a neck ring. The neck ring has one or more receiving channels. The receiving channels have first channel and a second channel extending at a first angle from an end of the first channel. A vapor plug has one or more pins. The one or more pins are configured to secure in the receiving channels.

In another aspect, a method is provided for securing a cryogenic storage vessel. The method may include placing vapor plug onto a cryogenic storage vessel. The cryogenic storage vessel may have a neck ring. The vapor plug may include a first pin and the neck ring may include a first receiving channel. The method may also include inserting the first pin into a first channel of the first receiving channel. The method may also include rotating the first pin into a second channel of the first receiving channel, the second channel extending at a first angle from an end of the first channel.

In another aspect, the method may include sealing the vapor plug to the cryogenic storage vessel. The method may include releasing gas from the cryogenic storage vessel as pressure of the cryogenic storage vessel increases. The method may include an interference tab on the second channel of the receiving channel. The interference tab may be configured to selectively prevent the rotation of the vapor plug. The method may include inserting a cryogenic material into an opening of the cryogenic storage vessel. The cryogenic material may be below an ambient temperature. The method may include releasing the vapor plug by applying a downward and rotational force to the vapor plug. The first pin may rotate out of the first channel of the first receiving channel.

In another aspect, the method may include removing the vapor plug by pulling the vapor plug upward. The first pin may be moved upward and out of the first channel of the first receiving channel.

In another aspect, the method may include a second pin and the neck ring includes a second receiving channel. The method may include inserting the second pin into a first channel of the second receiving channel. The method may include rotating the second pin into a second channel of the second receiving channel.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1 shows a perspective view an exemplary cryogenic storage vessel comprising a vapor plug locking mechanism according to an aspect of the invention;

FIG. 2 shows an exploded view of an exemplary cryogenic storage vessel comprising a vapor plug locking mechanism, including a vapor plug lid, a neck ring and a cryogenic storage vessel, according to an aspect of the invention;

FIG. 3 shows a perspective view of a cryogenic shipping container including an exemplary neck, and the receiving channels according to an aspect of the invention;

FIG. 4 shows a perspective cross sectional view an exemplary cryogenic storage vessel comprising a vapor plug locking mechanism according to an aspect of the invention;

FIG. 5 shows a close-up view of an exemplary receiving channel and pin according to an aspect of the invention;

FIG. 6A shows the vapor plug locking mechanism including a pin inserted in a receiving channel according to an aspect of the invention;

FIG. 6B shows the vapor plug locking mechanism including a pin inserted in a receiving channel in the locked position, according to an aspect of the invention;

FIG. 7 shows a cross sectional view of an exemplary vapor plug including the vapor plug locking mechanism according to an aspect of the invention;

FIG. 8 illustrates a method for securing a cryogenic storage vessel, in accordance with various embodiments; and

FIG. 9 illustrates a further method for securing a cryogenic storage vessel, in accordance with various embodiments.

### DETAILED DESCRIPTION

Disclosed herein are systems, apparatuses and devices for transporting and storing material maintained at cryogenic or other lower temperatures by a cooling agent. The cooling agent may be a liquid or gas, such as liquid nitrogen. The system, apparatus or device may include a vapor plug locking mechanism that locks, holds or otherwise is configured to retain the vapor plug around the neck of a cryogenic storage vessel. A locking mechanism may be used to partially seal a vapor plug to a dewar, wherein the locking mechanism is configured to allow the inner vessel of the dewar to release gas as the pressure or temperature of the dewar changes. The inner vessel of the dewar may have a neck portion. The neck portion may have an opening that receives the material in the dewar and stores the material in the inner vessel of the dewar. The dewar may be a double-walled and vacuum-insulated container that is used to transport materials at cryogenic temperatures. The dewar may have an inner wall that is lined with an absorbent material and an outer wall, which forms an inner and outer vessel.

A vapor plug or other lid may be used to partially seal a lid to the body of the dewar. The vapor plug may be attached to allow gas to release as pressure and/or temperature changes in the dewar. The vapor plug may seal the lid to the dewar to prevent the gas from evaporating and may allow the pressure of the dewar to equalize by releasing gas or air. The vapor plug may be retained so that it does not extend excessively from the dewar. For instance, a dewar that is spherical may rotate inside a housing and have a vapor plug that must stay sufficiently inside the dewar that it does not contact the housing and interfere with rotation. The vapor plug, by releasing gas as the pressure increases, assists in maintaining the temperature of the dewar. Further, by reducing the amount of liquid or gas that evaporates, the vapor plug also minimizes the amount of warm air that is pulled in to replace the evaporated liquid or gas, which prolongs the amount of time that the dewar can maintain the cryogenic temperatures.

The lid or vapor plug may attach to the neck of the dewar. The vapor plug and neck of the dewar may have a locking mechanism. The locking mechanism on the vapor plug may be configured to attach to the locking mechanism of the dewar. The locking mechanism, in various embodiments, may include a neck ring on the neck of the dewar. The neck ring may be attached to the neck of the dewar. The neck ring may have one or more “L” shaped channels. The vapor plug or lid may have one or more pins. The pins of the vapor plug may be designed to fit into the channels on the neck of the dewar.

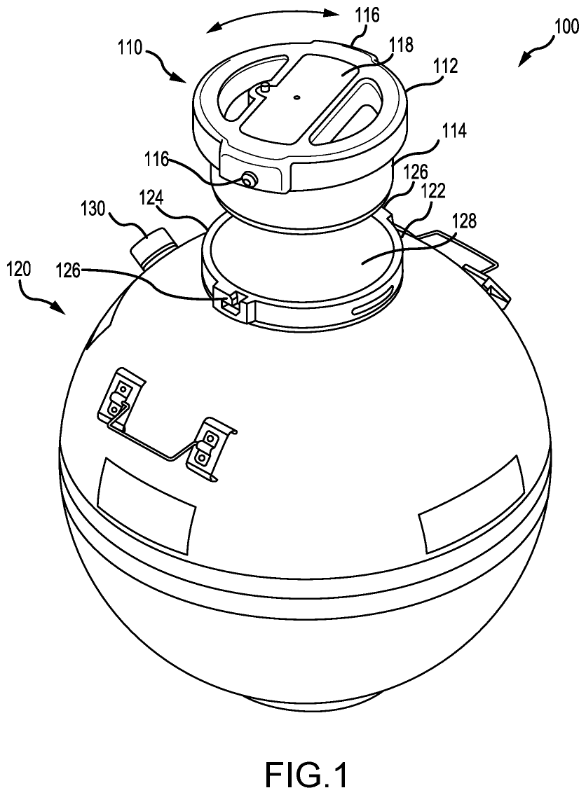

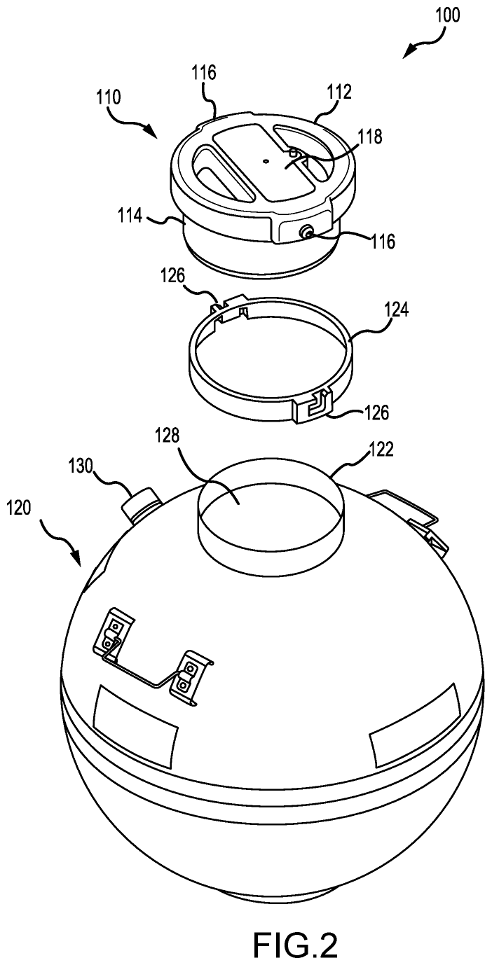

With reference to FIGS. 1 and 2, in various embodiments, a cryogenic storage vessel 100 may comprise a vapor plug 110 and a dewar 120. In various embodiments, the dewar 120 includes a neck 122 that protrudes from the top of the device. The neck 122 may have a neck ring 124. The neck ring 124 may adhere to the neck 122 using an appropriate manner for strength, heat transfer, or industry practices. The neck ring 124 may be a separate component or part of the neck 122. The neck ring 124 may be fabricated using plastic, metal, or composite. The neck ring 124 may include receiving channels 126. The neck 122 may include an opening 128 that allows materials to be inserted into the dewar 120.

In various embodiments, the vapor plug 110 may partially seal the dewar 120. That is, the vapor plug 110 allows the liquid or gas to escape the dewar 120 to at least partially equalize the pressure within the dewar 120 relative to an external pressure, but may also, obstruct and/or reduce the amount of liquid or gas that escapes to limit evaporation and limit warm air from entering into the dewar 120. This maintains the cryogenic temperatures within the dewar 120 to allow for continued cryogenic storage of the material stored within the dewar 120. The vapor plug may be retained in sufficient obstructing relation to the opening of the dewar that it does not extend outward into a contacting relationship with a surrounding housing of the dewar. This is particularly important for dewars that rotate or move in a housing (such as a spherical dewar) and have a vapor plug that is desired to remain in non-contacting relationship with the housing so that the rotation is free. In various embodiments, the dewar 100 may comprise a pump out port 130. The pump-out port 130 may be used to release or insert gas or air into a void between inner and outer walls of the dewar 100, as will be described further herein.

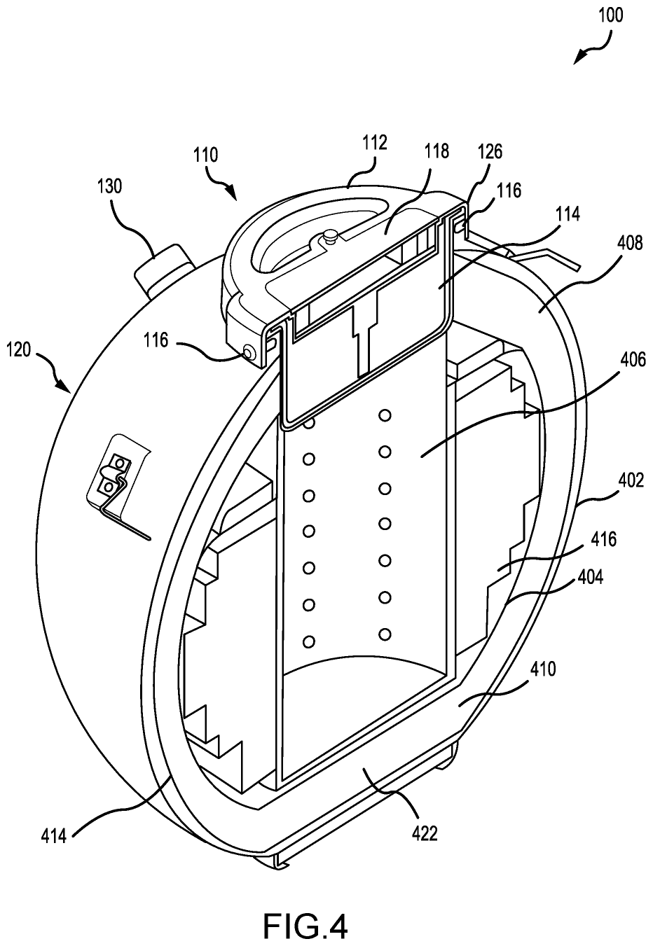

In various embodiments, the vapor plug 110 may comprise a cap 112, a vapor plug neck 114, and a vapor plug handle 118. The neck 114 may be configured to be inserted into the opening 128 of the dewar 120. The handle 118 may have a handle or grip that allows a user to twist the vapor plug 110 in a clockwise or counter-clockwise direction to insert and rotate at least a portion of the neck 114 into the opening 128. The vapor plug 110 may be removable. That is, the vapor plug 110 may be inserted into the opening 128 of the dewar 120 to seal or partially seal the dewar 120 and prevent access to the payload area 406 (FIG. 4). The handle 118 and/or the neck 114 of the vapor plug 110 may be made from a relatively thermally non-conductive material, such as a polymer or fiberglass-like material.

The vapor plug 110, in accordance with various embodiments, may comprise one or more pins 116. The pins 116 may be located on the cap 112 of the vapor plug 110. With momentary additional reference to FIG. 4, the pins 116 may extend radially inward towards the center of the vapor plug 110. The pins 116 may extend radially inward toward a central axis of the vapor plug 110. In various instances, the pins 116 extend inward toward a center of a cross-section of the vapor plug 110. In further instances, the pins 116 may extend inwardly at an angle. The pins 116 may be made of metal, plastic, or other composite material.

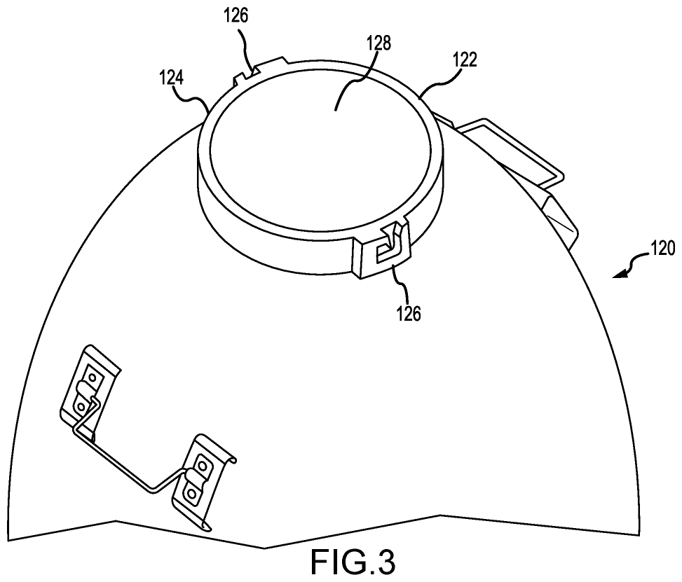

With reference to FIG. 3 and continued reference to FIGS. 1 and 2, in various embodiments, the dewar 120 may have a neck ring 124 attached to the neck 122. In various embodiments, the neck ring 124 may have one or more receiving channels 126. In various embodiments, the neck ring 124 may have one receiving channel 126 or more than one receiving channel 126. In various embodiments, a receiving channel 126 may be on opposite sides of the neck ring 124. In various embodiments, three or more receiving channels 126 may be equally distanced from each other on the neck ring 124.

In various embodiments, the vapor plug 110 may be turned or twisted clockwise and/or counter-clockwise, as shown in FIG. 1. For example, the vapor plug 110 may be turned clockwise or counter-clockwise when inserting the vapor plug neck 114 into the opening 128 of the dewar 120, wherein the vapor plug 110 may be rotated for the one or more pins 116 to enter the one or more receiving channels 126. With continued reference to this example, the vapor plug 110 may be rotated clockwise to secure the vapor plug 110 onto the opening 128 of the dewar 120. The vapor plug 110 may be turned counter-clockwise to remove the vapor plug 110 from the opening 128 to allow insertion of the liquid or gas into the dewar 120. In another example, the vapor plug 110 may be turned counter-clockwise when inserted into the opening 128 to secure the vapor plug 110 within the opening 128 and turned clockwise to remove the vapor plug 110 from the opening 128. The vapor plug 110 may be inserted into the opening 128 of the dewar 120 such that there remains a gap that allows gas to escape to prevent pressure from building up as the liquid within the dewar 120 evaporates.

With reference to FIG. 4 and continued reference to FIGS. 1-3, in various embodiments, the dewar 120 may have an outer wall 402, inner wall 404, and an opening 128. The cryogenic storage vessel 100 may have a plug, such as a vapor plug 110, which may be inserted into the opening 128 to seal or partially seal the dewar 120 while allowing some gas to escape, as shown in FIG. 4 for example. The opening 128 leads to a cavity or payload area 406 that is within the dewar 120. FIG. 4 shows the payload area 406 in the cross-sectional view of the dewar 120. The dewar 120 may form an at least partial vacuum between the inner wall 404 and the outer wall 402 to hold or store a liquid or gas below ambient temperatures. The dewar 120 may have a pump-out port 130. The pump-out port 130 may be used to create a vacuum between the inner wall 404 and the outer wall 402 of the dewar 120, which allows the space in between the inner wall 404 and the outer wall 402 to be completely evacuated.

In various embodiments, the dewar 120 has an outer wall 402 and an inner wall 404 with a vacuum between the outer wall 402 and the inner wall 404. The outer wall 402 has an opening 128 that allows a liquid or gas to be inserted or placed into the payload area 406. The opening 128 may be positioned opposite a center of gravity or mass 422 of the dewar 120, such that the opening 128 remains upright when the dewar 120 is passively stabilized. The vapor plug 110 may be partially sealed to allow gases to escape from the payload area 406 of the dewar 120 through the opening 128 to relieve the gas expansion within the dewar 120.

In various embodiments, the inner wall 404 forms and/or encloses the payload area 406 within the dewar 120. The payload area 406 may be a cylindrical cavity within the dewar 120 that extends longitudinally from the top portion 408 through to the bottom portion 410 of the dewar 120. The payload area 406 may hold or store payload material and cooling material such as a liquid or gas below ambient temperatures.

In various embodiments, a cooling material 416 may be placed in the payload area 406 and/or between the payload area 406 and the inner wall 404. The cooling material 416 may be used to keep the contents of the dewar 120 below ambient temperatures. The cooling material 416 may be dry ice, gas, liquid such as liquid nitrogen, or another cooling compound. In further embodiments, a cooling material 416 may be placed between the outer wall 402 and the inner wall 404.

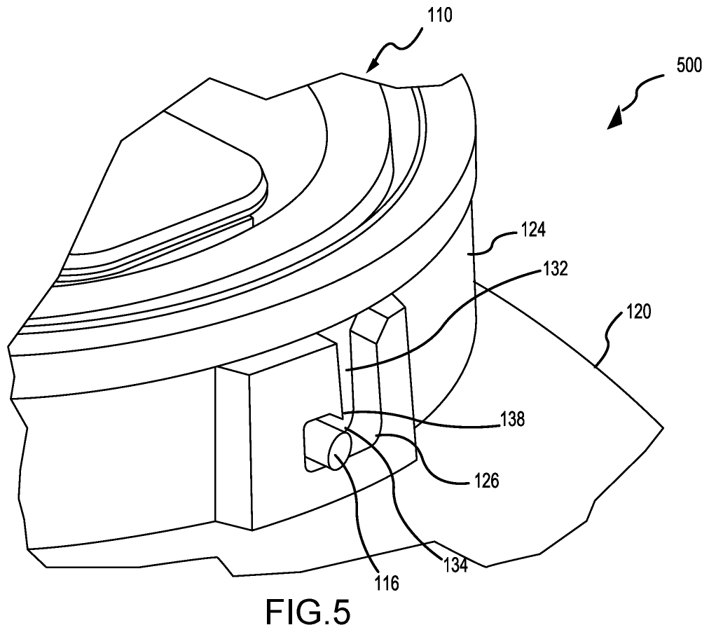

With reference to FIG. 5, in accordance with various embodiments, a vapor plug 110 may be attached to the dewar 120 using a locking mechanism 500. With reference to FIG. 5, the cap 112 is not shown to show the internal components of the locking mechanism 500. The locking mechanism 500 may comprise a vapor plug 110 including a pin 116 and a receiving channel 126. The pin 116 may be configured to fit into the receiving channel 126. The receiving channel 126 may have a first channel 132 and a second channel 134. The second channel may extend at a first angle from the end of the first channel 132. For example, the first angle may be similar to 90 degrees. In various embodiments, the first channel 132 may extend vertically with respect to the opening 128 or the dewar 120. The second channel 134, may extend horizontally with respect to the opening 128 of the dewar 120. In various embodiments, the first channel 132 may be in connection with the second channel 132, wherein the pin 116 may slide along a first direction (e.g., vertically) into the first channel 132 then along a second direction (e.g., horizontally) into the second channel 134. The receiving channel 126, in various embodiments, is configured to receive a pin 116, wherein the pin 116 enters into the first channel 132, then the pin 116 may be configured to slide into the second channel 134. The receiving channel 126 may further comprise an interference tab 138. The interference tab 138 may extend into one or both of the first channel 132 and/or the second channel 134 to mechanically interfere with movement of the pin 116 to limit the pin 116 from inadvertent removal from the receiving channels 126.

In various embodiments, the locking mechanism 500 locks when the vapor plug 110 is inserted within the opening 128 of the dewar 120 and rotated, wherein the pin 116 locks into the receiving channel 126. When the vapor plug 110 is inserted into the dewar 120, the locking mechanism 500 locks the vapor plug 110 in place with the dewar 120 to prevent the vapor plug 110 from falling out when the dewar 120 is oriented or rotated in different directions. When the vapor plug 110 is locked to the dewar 120 using the locking mechanism 500, some movement may be allowed to provide a gap between the vapor plug 110 and the dewar 120. In various embodiments, some movement may be allowed between the vapor plug 110 and the opening 128 of the dewar 120 which may allow gas to escape due to the expansion of the gas or evaporation of the liquid within the dewar 120 to prevent pressure from building up within the dewar 120.

In various embodiments, the locking mechanism 500 may have an interference tab 138. The interference tab 138 may be a notch or extension into the receiving channel 126. The interference tab 138 may prevent the vapor plug 110 from being removed from the dewar 120, unless a downward and rotational force is applied to the vapor plug 110. For example, when a downward and rotational force is applied to the vapor plug 110, the pin 116 may be rotated into or out of the first channel 132. The interference tab 138 prevents the unwanted removal of the vapor plug 110.

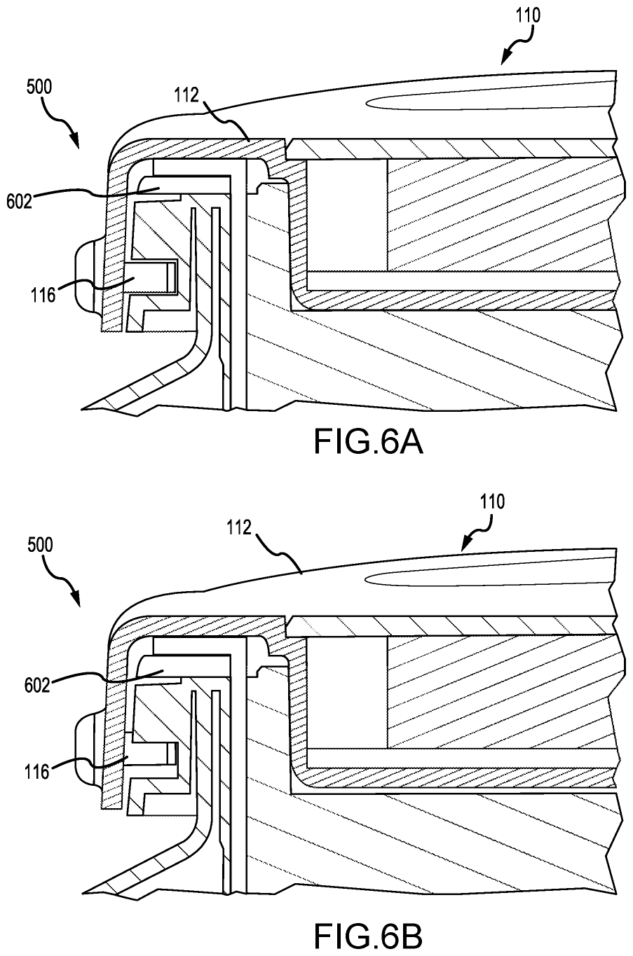

With reference to FIGS. 6A and 6B, and periodic reference to FIGS. 1-5, the locking mechanism 500 may comprise a pin 116 inserted into a receiving channel 126. FIG. 6A, shows an exemplary embodiment where the pin 116 is fully inserted in the first channel 132 of the receiving channel 126. For example, a downward force may be applied to the vapor plug 110 so the pin 116 is fully inserted in the first channel 132. FIG. 6B shows an exemplary embodiment where the pin 116 is inserted fully in the second channel 134 of the receiving channel 126. For example, a rotational force has been applied to rotate the pin 116 into the second channel 134. In this example, a downward force may be applied to allow the pin 116 to enter the second channel 134 as to not be stopped by the interference tab 138. When the pin 116 is fully inserted in the second channel 134 of the receiving channel 126, the vapor plug 110 is in the locked position on the dewar 120. The interference tab 138 may prevent the pin 116 from rotating outside of the second channel 134 without a downward and rotational force applied to the vapor plug 110.

In various embodiments, the vapor plug 110 may include a gasket 602. The gasket 602 may be positioned between the vapor plug 110 and the neck 114 of the dewar 120. One or more gaskets 602 may be placed along the circumferential perimeter of the vapor plug 110 and the neck 114. The gasket 602 may be an O-ring, or other device that partially seals the vapor plug 110 to the neck 114 of the dewar 120 when the vapor plug 110 is inserted or locked on the dewar 120. The one or more gaskets 602 may be made from rubber, silicone, fiberglass, polytetrafluoroethylene (PTFE), a plastic or elastic polymer or other pliable material, which may be compressible and suitable for a wide range of pressures and/or temperatures.

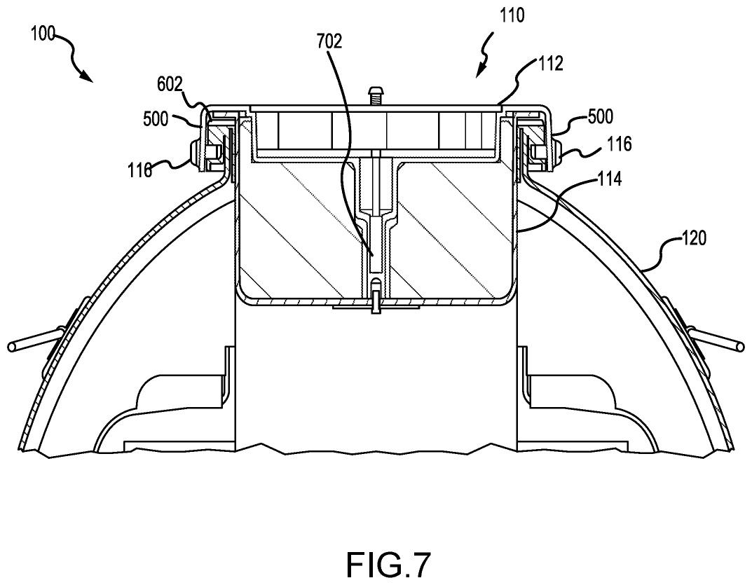

In various embodiments, the pins 116 may move upward or downward slightly to allow gas to vent from the vapor plug 110. For example, in various embodiments the vapor plug 110 may move up and down, by way of the pin 116 moving up and down in the horizontal channel 134. In accordance with this embodiment, the vapor plug 110 may allow gas to release by the gasket 602. With reference to FIG. 7, and periodic reference to FIGS. 1-6B, the vapor plug 110 may be locked to a dewar 120 using a locking mechanism 500. The neck 114 of the vapor plug 110 may be inserted into the dewar 120. A locking mechanism 500 may be positioned at opposite sides of the cap 112 of the vapor plug 110. The locking mechanisms 500 may be evenly distanced to provide balance to the vapor plug 110. In various embodiments, there may be two or more locking mechanisms 500. The locking mechanism 500 allows the vapor plug 110 to attach to the dewar 120 by opening 128 to retain the vapor plug 110 and allow gases to vent freely from the opening 128 of the dewar 120. Since the shape of the feature allows only a small amount of vertical movement of the pin 116, the vapor plug 110 is never completely sealed.

With continued reference to FIG. 7, the cryogenic storage vessel 100 may include an electronic thermocouple 702, which may be positioned, embedded or included within, or connected to the neck 114 of the vapor plug 110. The electronic thermocouple 702 may be an electronic device or sensor that measures and monitors the temperature within the dewar 120. The electronic thermocouple 702 may wirelessly transmit and/or communicate with another electronic device, such as a smart data logger, using a wireless protocol. The electronic thermocouple 702 may transmit and/or communicate with another electronic device, such as a smart data logger, using a wired connection. The electronic thermocouple 702 may communicate and provide the temperature to the smart data logger and/or may receive instructions from the smart data logger to monitor the temperature. The smart data logger may display or otherwise communicate the temperature to a user or another electronic platform. This allows for real-time monitoring of the temperature within the dewar 120.

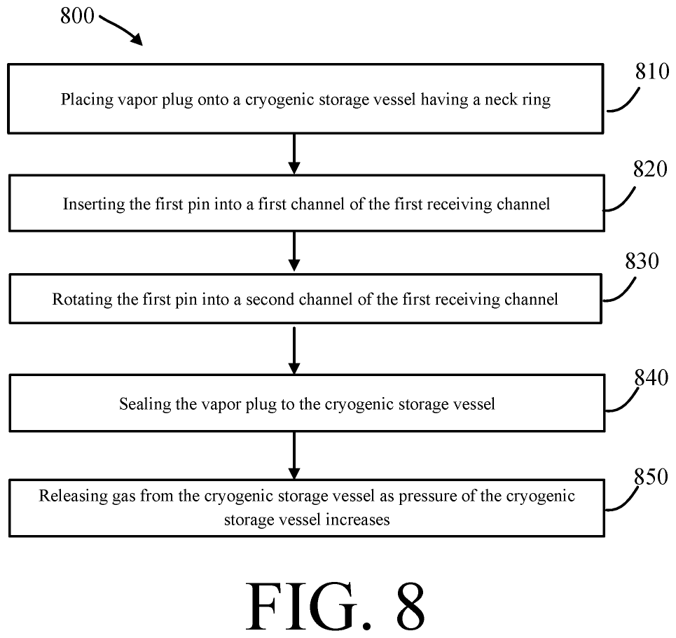

In accordance with various embodiments, with reference to FIG. 8 and continued reference to FIGS. 1-7, a method 800 for securing a cryogenic storage vessel 100 is provided. The method 800 may include placing vapor plug onto a cryogenic storage vessel having a neck ring (block 810). The vapor plug may comprise a first pin and the neck ring may comprise a first receiving channel.

The method 800 may include inserting the first pin into a first channel of the first receiving channel (block 820). The one or more pins may be configured to enter into the one or more receiving channels. The method 800 may further include rotating the first pin into a second channel of the first receiving channel (block 830). The method 800 may further include sealing the vapor plug to the cryogenic storage vessel (block 840). The method 800 may further include releasing gas from the cryogenic storage vessel as pressure of the cryogenic storage vessel increases (block 850). The method 800 may further include selectively preventing the rotation of the vapor plug by an interference tab on the second channel of the receiving channel.

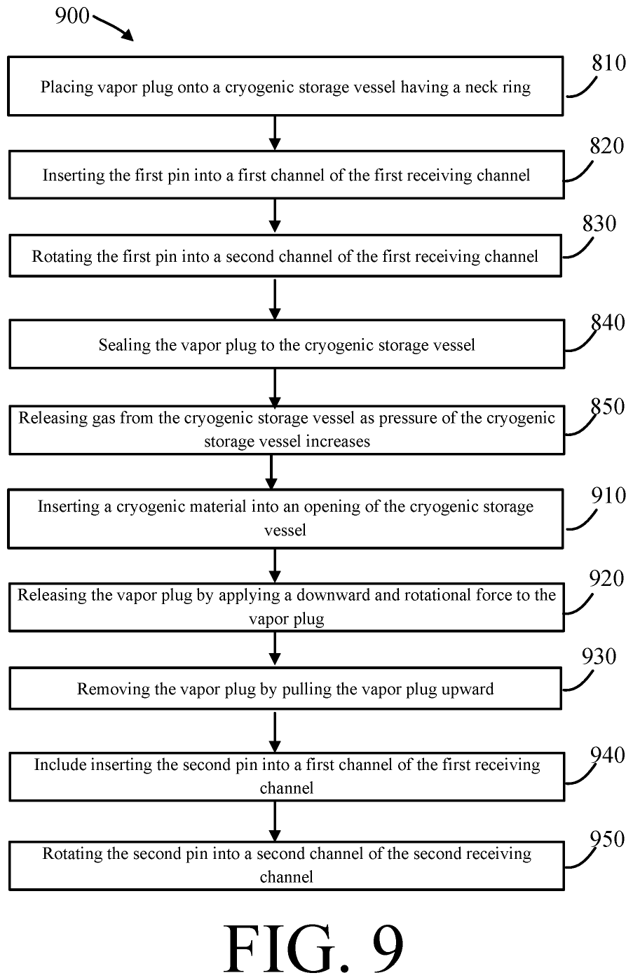

Referring now to FIG. 9, and with continued reference to FIGS. 1-7, a further method 900 for securing a cryogenic storage vessel 100 is provided. The method 900 may include placing vapor plug onto a cryogenic storage vessel having a neck ring (block 810). The vapor plug may comprise a first pin and the neck ring may comprise a first receiving channel. The method 900 may include inserting the first pin into a first channel of the first receiving channel (block 820). The one or more pins may be configured to enter into the one or more receiving channels. The method 900 may further include rotating the first pin into a second channel of the first receiving channel (block 830). The method 900 may further include sealing the vapor plug to the cryogenic storage vessel (block 840). The method 900 may further include releasing gas from the cryogenic storage vessel as pressure of the cryogenic storage vessel increases (block 850). The method 900 may further include selectively preventing the rotation of the vapor plug by an interference tab on the second channel of the receiving channel.

The method 900 may further include inserting a cryogenic material into an opening of the cryogenic storage vessel, wherein the cryogenic material is below an ambient temperature (block 910). The method 900 may further include releasing the vapor plug by applying a downward and rotational force to the vapor plug, wherein the first pin rotates out of the second channel of the first receiving channel (block 920). The method 900 may further include removing the vapor plug by pulling the vapor plug upward, wherein the first pin is moved upward and out of the first channel of the first receiving channel (block 930). The vapor plug of the method 900 may comprise a second pin and the neck ring comprises a second receiving channel. The method 900 may further include inserting the second pin into a first channel of the second receiving channel (block 940). The method 900 may also include rotating the second pin into a second channel of the second receiving channel (block 950).

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A vapor plug locking mechanism comprising:
a vapor plug having a first pin;
a cryogenic storage vessel having an opening and a neck ring around the opening, the neck ring having a first receiving channel;
the first receiving channel having a first channel and a second channel extending at a first angle from an end of the first channel; and
the first receiving channel configured to receive the first pin,
wherein the first pin slides into the first channel then rotates into the second channel.

2. The vapor plug locking mechanism of claim 1, wherein the first channel is relatively vertical with respect to an orientation of the opening of the dewar and the second channel is relatively horizontal with respect to the orientation of the opening of the dewar, wherein the first angle is similar to 90 degrees.

3. The vapor plug locking mechanism of claim 1, wherein the receiving channel comprises an interference tab, the interference tab configured to selectively prevent the pin from rotating.

4. The vapor plug locking mechanism of claim 1, wherein the vapor plug further comprises a gasket, the gasket configured to selectively seal the vapor plug to the neck of the cryogenic storage vessel.

5. The vapor plug locking mechanism of claim 1, wherein the vapor plug further comprises a vapor plug handle, the handle configured to insert and rotate the vapor plug into the opening of the cryogenic storage vessel.

6. The vapor plug locking mechanism of claim 1, wherein the first pin extends radially inward.

7. The vapor plug locking mechanism of claim 1, wherein the vapor plug comprises a second pin and the neck comprises at least two receiving channels.

8. A vapor plug locking mechanism comprising:
a cryogenic storage vessel configured to contain a material below an ambient temperature;
an opening of the cryogenic storage vessel having a neck ring;
one or more receiving channels on the neck ring, the receiving channels having a first channel and a second channel extending at a first angle from an end of the first channel; and
a vapor plug having one or more pins, the one or more pins configured to secure in the receiving channels.

9. The vapor plug locking mechanism of claim 8, wherein the first channel is relatively vertical with respect to an orientation of the opening of the dewar and the second channel is relatively horizontal with respect to the orientation of the opening of the dewar, wherein the first angle is similar to 90 degrees.

10. The vapor plug locking mechanism of claim 8, wherein the one or more of the receiving channels comprise an interference tab, the interference tab configured to selectively prevent the one or more of the pins from rotating.

11. The vapor plug locking mechanism of claim 8, wherein the vapor plug further comprises a gasket, the gasket configured to selectively seal the vapor plug to the neck of the cryogenic storage vessel.

12. The vapor plug locking mechanism of claim 8, wherein the vapor plug further comprises a vapor plug handle, the handle configured to insert and rotate the vapor plug into the opening of the cryogenic storage vessel.

13. The vapor plug locking mechanism of claim 8, wherein the one or more pins extend radially inward.

14. A method for securing a cryogenic storage vessel comprising:
placing a vapor plug onto a cryogenic storage vessel having a neck ring, wherein the vapor plug comprises a first pin and the neck ring comprises a first receiving channel;
inserting the first pin into a first channel of the first receiving channel; and
rotating the first pin into a second channel of the first receiving channel, the second channel extending at a first angle from an end of the first channel.

15. The method of claim 14, wherein the first channel is relatively vertical with respect to an orientation of the opening of the dewar and the second channel is relatively horizontal with respect to the orientation of the opening of the dewar, wherein the first angle is similar to 90 degrees.

16. The method for securing a cryogenic storage vessel of claim 14, further comprising:
sealing the vapor plug to the cryogenic storage vessel; and
releasing gas from the cryogenic storage vessel.

17. The method for securing a cryogenic storage vessel of claim 14, wherein the neck ring further comprises:
an interference tab on the second channel of the receiving channel, wherein the interference tab is configured to selectively prevent the rotation of the vapor plug.

18. The method for securing a cryogenic storage vessel of claim 14, further comprising:
inserting a cryogenic material into an opening of the cryogenic storage vessel, wherein the cryogenic material is below an ambient temperature.

19. The method for securing a cryogenic storage vessel of claim 14, further comprising:
releasing the vapor plug by applying a downward and rotational force to the vapor plug, wherein the first pin rotates out of the second channel of the first receiving channel.

20. The method for securing a cryogenic storage vessel of claim 18, further comprising:
removing the vapor plug by pulling the vapor plug upward, wherein the first pin is moved upward and out of the first channel of the first receiving channel.
